(19) United States
(12) Patent Application Publication
(10) Pub. No.: US 2019/0139328 A1
(43) Pub. Date: May 9, 2019

(54) DRIVERLESS TRANSPORTATION SYSTEM

(71) Applicant: TOYOTA JIDOSHA KABUSHIKI KAISHA, Toyota-shi (JP)

(72) Inventors: Yasunao YOSHIZAKI, Okazaki-shi (JP); Koji TAGUCHI, Sagamihara-shi (JP); Masaki WASEKURA, Toyota-shi (JP); Nobuhide KAMATA, Susono-shi (JP)

(73) Assignee: TOYOTA JIDOSHA KABUSHIKI KAISHA, Toyota-shi (JP)

(21) Appl. No.: 16/125,849

(22) Filed: Sep. 10, 2018

(30) Foreign Application Priority Data
Nov. 7, 2017 (JP) 2017-214969

(51) Int. Cl. G07C 5/00; G05D 1/02; G07C 5/08; G06K 9/00; G06K 9/62

(52) U.S. Cl. CPC G07C 5/008; G05D 1/021; G06K 9/6202; G06K 9/00832; G07C 5/0866

(57) ABSTRACT

A driverless transportation system includes: an autonomous driving vehicle that a user boards; and an abnormal event check device that checks whether or not an abnormal event exists in a passenger room of the autonomous driving vehicle after the user gets off. The autonomous driving vehicle uses a passenger room monitor to acquire, as a comparison-target image, an image of the passenger room after the user gets off the autonomous driving vehicle. The abnormal event check device: acquires a reference image being an image of the passenger room before the user boards the autonomous driving vehicle; acquires the comparison-target image; compares the comparison-target image with the reference image to determine whether or not the abnormal event exists; and notifies the user terminal or a management center, when it is determined that the abnormal event exists.

### BACKGROUND

### Technical Field

The present disclosure relates to an autonomous driving vehicle and a driverless transportation system that provide a driverless transportation service.

### Background Art

Patent Literature 1 discloses a driverless transportation service using an autonomous driving vehicle that is capable of driving without a human driver. The autonomous driving vehicle heads to a pickup location for picking up a user. On arriving at the pickup location, the autonomous driving vehicle stops and opens a door. The user gets in the autonomous driving vehicle and performs an authentication operation. When the authentication of the user is completed, the autonomous driving vehicle closes the door and locks the door. After that, the autonomous driving vehicle departs and autonomously travels toward a destination desired by the user.

### List of Related Art

Patent Literature 1: Japanese Laid-Open Patent Publication No. 2015-191264

### SUMMARY

There is a possibility that an abnormal event exists in a passenger room of the autonomous driving vehicle after the user gets off. For example, there is a possibility that an object or trash is left behind in the passenger room. As another example, there is a possibility that dirt exists in the passenger room. As still another example, there is a possibility that a part in the passenger room is damaged or stolen. In the case of the driverless transportation service, however, there is no driver in the autonomous driving vehicle and thus there is a possibility that a next user boards the autonomous driving vehicle in which the abnormal event still remains. In that case, the next user on board feels senses of discomfort and inconvenience. This causes decrease in confidence in the driverless transportation service and deteriorates usefulness of the driverless transportation service.

An object of the present disclosure is to provide a technique that can cope with the abnormal event existing in the passenger room of the autonomous driving vehicle after the user gets off, in the driverless transportation service.

A first disclosure provides a driverless transportation system that provides a driverless transportation service for a user.

The driverless transportation system includes:

an autonomous driving vehicle that the user boards; and

an abnormal event check device that checks whether or not an abnormal event exists in a passenger room of the autonomous driving vehicle after the user gets off.

The abnormal event is a change within the passenger room between before the user boards the autonomous driving vehicle and after the user gets off the autonomous driving vehicle.

The autonomous driving vehicle includes:

a passenger room monitor that images the passenger room; and

a control device that uses the passenger room monitor to acquire, as a comparison-target image, an image of the passenger room after the user gets off the autonomous driving vehicle.

The abnormal event check device performs:

reference acquisition processing that acquires a reference image being an image of the passenger room before the user boards the autonomous driving vehicle;

comparison-target acquisition processing that acquires the comparison-target image;

determination processing that compares the comparison-target image with the reference image to determine whether or not the abnormal event exists; and

abnormal event notification processing that notifies a terminal of the user or a management center managing the driverless transportation service, when it is determined that the abnormal event exists.

A second disclosure further has the following feature in addition to the first disclosure.

The abnormal event includes at least one of object addition, dirt occurrence, part loss, and part damage within the passenger room as compared to before the user boards the autonomous driving vehicle.

A third disclosure further has the following feature in addition to the second disclosure.

When the abnormal event is the object addition, the abnormal event notification processing includes notifying at least the terminal of the user.

A fourth disclosure further has the following feature in addition to the second or third disclosure.

When the abnormal event is the dirt occurrence, the part loss, or the part damage, the abnormal event notification processing includes notifying at least the management center.

A fifth disclosure further has the following feature in addition to any one of the first to fourth disclosures.

The abnormal event check device is a management server placed in the management center.

The control device transmits the comparison-target image to the management server.

The comparison-target acquisition processing includes receiving the comparison-target image transmitted from the autonomous driving vehicle.

A sixth disclosure further has the following feature in addition to the fifth disclosure.

A pickup period is a period from when the autonomous driving vehicle receives information of a dispatch request made by the user to when the user boards the autonomous driving vehicle.

The control device uses the passenger room monitor to acquire the reference image in the pickup period and transmits the reference image to the management server.

The reference acquisition processing includes receiving the reference image transmitted from the autonomous driving vehicle.

A seventh disclosure further has the following feature in addition to the fifth disclosure.

The reference image is beforehand registered in the management server.

The reference acquisition processing includes reading the registered reference image.

An eighth disclosure further has the following feature in addition to any one of the first to fourth disclosures.

The abnormal event check device is the control device.

A ninth disclosure further has the following feature in addition to the eighth disclosure.

A pickup period is a period from when the autonomous driving vehicle receives information of a dispatch request made by the user to when the user boards the autonomous driving vehicle.

The reference acquisition processing includes using the passenger room monitor to acquire the reference image in the pickup period.

A tenth disclosure further has the following feature in addition to the eighth disclosure.

The reference image is beforehand registered in a memory device of the autonomous driving vehicle.

The reference acquisition processing includes reading the registered reference image from the memory device.

According to the present disclosure, the abnormal event check device checks whether or not the abnormal event exists in the passenger room of the autonomous driving vehicle after the user gets off. When the abnormal event exists, the abnormal event check device notifies the user terminal or the management center. Due to the notification, it is expected that the abnormal event is removed from the autonomous driving vehicle. As a result, it is suppressed that a next user boards the autonomous driving vehicle in which the abnormal event still remains. This contributes to increase in confidence in the driverless transportation service. Moreover, deterioration of usefulness of the driverless transportation service is prevented.

### BRIEF DESCRIPTION OF DRAWINGS

FIG. 1 is a block diagram schematically showing a configuration of a driverless transportation system according to an embodiment of the present disclosure;

FIG. 2 is a conceptual diagram for explaining abnormal event check processing by an abnormal event check device according to the embodiment of the present disclosure;

FIG. 3 is a flow chart showing the abnormal event check processing by the abnormal event check device according to the embodiment of the present disclosure;

FIG. 4 is a block diagram showing a configuration example of an autonomous driving vehicle according to the embodiment of the present disclosure;

FIG. 5 is a flow chart showing a first example of the abnormal event check processing according to the embodiment of the present disclosure;

FIG. 6 is a flow chart showing a second example of the abnormal event check processing according to the embodiment of the present disclosure;

FIG. 7 is a flow chart showing a third example of the abnormal event check processing according to the embodiment of the present disclosure; and

FIG. 8 is a flow chart showing a fourth example of the abnormal event check processing according to the embodiment of the present disclosure.

### EMBODIMENTS

Embodiments of the present disclosure will be described below with reference to the attached drawings.

### 1. Driverless Transportation System

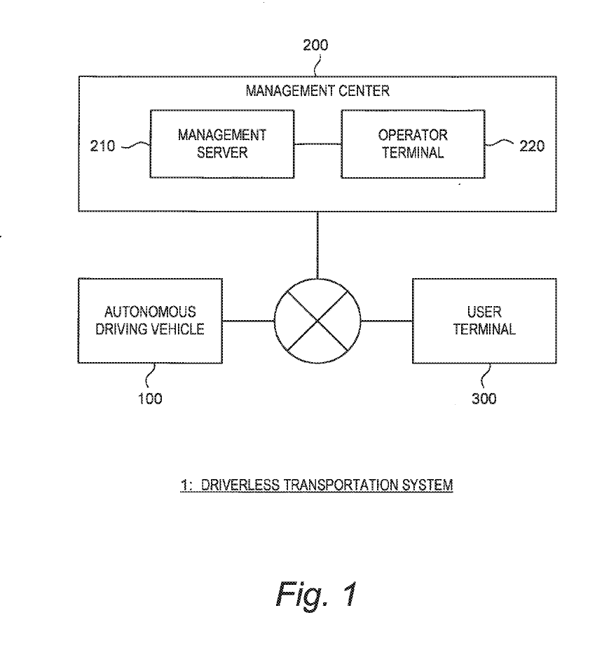

FIG. 1 is a block diagram schematically showing a configuration of a driverless transportation system 1 according to the present embodiment. The driverless transportation system 1 provides a driverless transportation service for a user. The driverless transportation system 1 includes an autonomous driving vehicle 100, a management center 200, and a user terminal 300.

The autonomous driving vehicle 100 is capable of autonomous driving without a human driver. The user rides the autonomous driving vehicle 100 and the autonomous driving vehicle 100 provides the driverless transportation service for the user. The autonomous driving vehicle 100 is capable of communicating with the management center 200 and the user terminal 300 through a communication network.

The management center 200 manages the driverless transportation service. A management server 210 and an operator terminal 220 are placed in the management center 200.

The management server 210 is a server that manages the driverless transportation service and the autonomous driving vehicle 100. For example, the management server 210 manages registration information of the user and an operating state of the autonomous driving vehicle 100. Moreover, the management server 210 is capable of communicating with the autonomous driving vehicle 100 and the user terminal 300 through the communication network.

The operator terminal 220 is a terminal operated by an operator. The operator can communicate a variety of information with the management server 210 through the operator terminal 220.

The user terminal 300 is a terminal of the user. The user terminal 300 is capable of communicating with the autonomous driving vehicle 100 and the management server 210 through the communication network. Such the user terminal 300 is exemplified by a smartphone.

A basic flow of the driverless transportation service is as follows.

First, the user uses the user terminal 300 to send a dispatch request. The dispatch request includes a pickup location desired by the user, and so forth. The dispatch request is transmitted to the management server 210 through the communication network. The management server 210 selects an autonomous driving vehicle 100 that provides the service for the user, and transmits information of the dispatch request to the selected autonomous driving vehicle 100. The autonomous driving vehicle 100 receiving the information automatically heads to the pickup location.

The autonomous driving vehicle 100 arrives at the pickup location and stops. The user boards the autonomous driving vehicle 100. The user notifies the autonomous driving vehicle 100 of a desired destination (drop-off location). Alternatively, the information of the destination may be included in the dispatch request. The autonomous driving vehicle 100 locks a door and then autonomously travels toward the destination. The autonomous driving vehicle 100 arrives at the destination and stops. The autonomous driving vehicle 100 unlocks the door and the user gets off the autonomous driving vehicle 100.

### 2. Outline of Abnormal Event Check Processing

There is a possibility that an abnormal event exists in a passenger room of the autonomous driving vehicle 100 after the user gets off. For example, there is a possibility that an object or trash is left behind in the passenger room. As another example, there is a possibility that dirt exists in the passenger room. As still another example, there is a possibility that a part in the passenger room is damaged or stolen. In the case of the driverless transportation service, however, there is no driver in the autonomous driving vehicle 100 and thus there is a possibility that a next user boards the autonomous driving vehicle 100 in which the abnormal event still remains. In that case, the next user on board feels senses of discomfort and inconvenience. This causes decrease in confidence in the driverless transportation service and deteriorates usefulness of the driverless transportation service.

In view of the above, the present embodiment provides a technique that can cope with the abnormal event existing in the passenger room of the autonomous driving vehicle 100 after the user gets off.

The “abnormal event” in the present embodiment is a change within the passenger room between before the user boards the autonomous driving vehicle 100 and after the user gets off the autonomous driving vehicle 100. For example, the abnormal event includes at least one of “object addition”, “dirt occurrence”, “part loss”, and “part damage” within the passenger room as compared to before the user boards the autonomous driving vehicle 100. The object that may be added is exemplified by a user's object left behind (e.g. the user terminal 300), an unnecessary object abandoned by the user (e.g. a plastic bottle, trash), and the like. The dirt that may occur is exemplified by user excrement, user vomit, and the like. The part that may be lost (stolen) is exemplified by a headrest and the like. The part that may be damaged is exemplified by a skin of a seat, a window, and the like.

Processing that checks whether or not any abnormal event exists in the passenger room of the autonomous driving vehicle 100 after the user gets off is hereinafter referred to as “abnormal event check processing”. A device that performs the abnormal event check processing is hereinafter referred to as an “abnormal event check device 10”. The abnormal event check device 10 may be the management server 210 managing the autonomous driving vehicle 100 or a control device mounted on the autonomous driving vehicle 100.

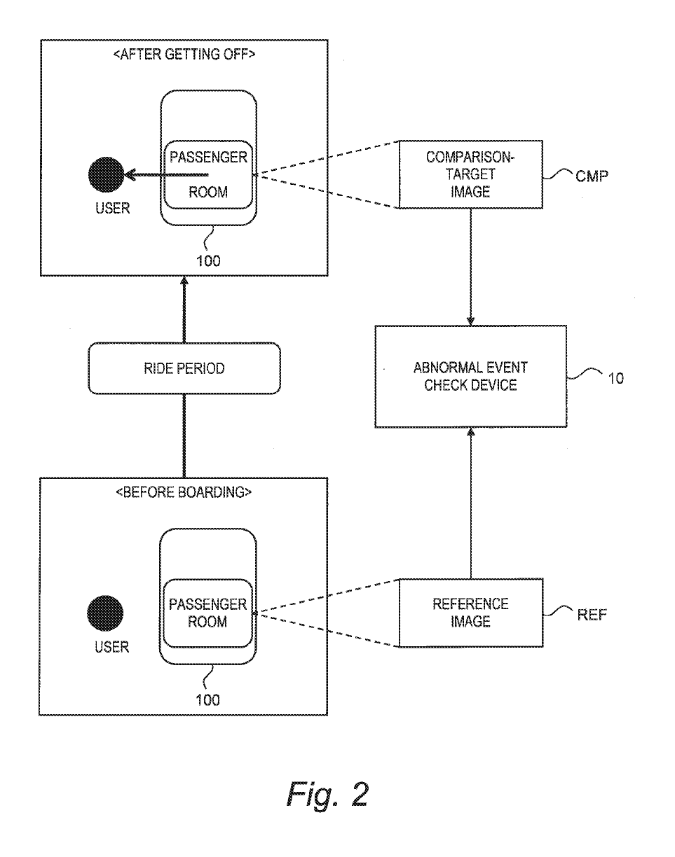

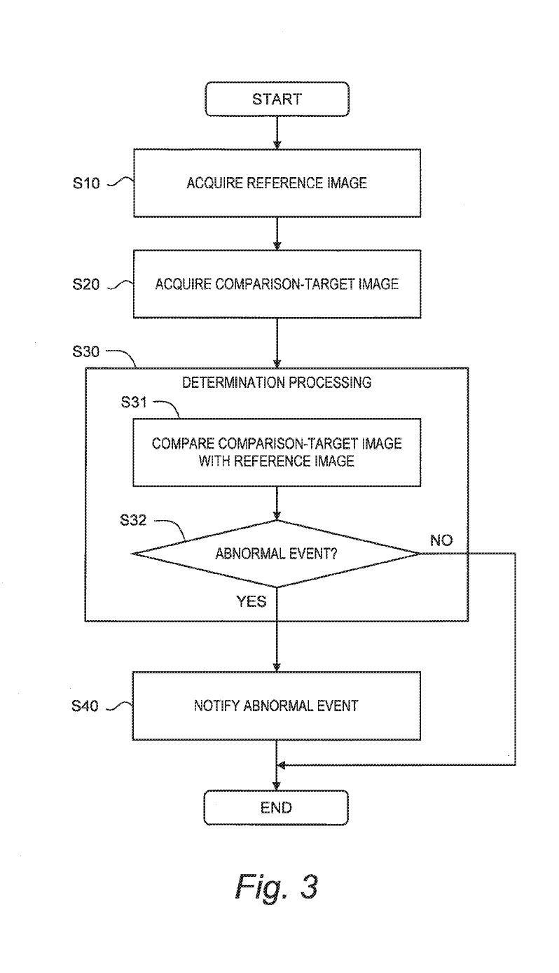

FIG. 2 is a conceptual diagram for explaining the abnormal event check processing according to the present embodiment. FIG. 3 is a flow chart showing the abnormal event check processing according to the present embodiment. The abnormal event check processing by the abnormal event check device 10 according to the present embodiment will be described with reference to FIGS. 2 and 3.

### Step S10:

The abnormal event check device 10 performs reference acquisition processing that acquires a “reference image REF”. The reference image REF is an image of the passenger room when nobody is on the autonomous driving vehicle 100, in particular an image of the passenger room before the user boards the autonomous driving vehicle 100. The reference image REF is used as a reference for detecting the abnormal event.

### Step S20:

After the user gets off the autonomous driving vehicle 100, the abnormal event check device 10 performs comparison-target acquisition processing that acquires a “comparison-target image CMP”. The comparison-target image CMP is an image of the passenger room when nobody is on the autonomous driving vehicle 100, in particular an image of the passenger room after the user gets off the autonomous driving vehicle 100.

### Step S30:

The abnormal event check device 10 performs determination processing that determines whether or not the abnormal event exists in the passenger room of the autonomous driving vehicle 100 after the user gets off. More specifically, the abnormal event check device 10 compares the comparison-target image CMP acquired in Step S20 with the reference image REF acquired in Step S10 (Step S31). If there is a difference (change) between the comparison-target image CMP and the reference image REF, the abnormal event check device 10 analyzes a feature and a pattern of the difference portion to determine to which type of abnormal event the difference corresponds. When it is determined that the abnormal event exists (Step S32; Yes), the processing proceeds to the following Step S40. On the other hand, when it is determined that no abnormal event exists (Step S32; No), the processing ends without Step S40.

### Step S40:

The abnormal event check device 10 performs abnormal event notification processing that notifies the user terminal 300 or the management center 200 of existence of the abnormal event.

For example, in the case where the abnormal event is the “object addition”, there is a high possibility that the user left behind the user's object or abandoned an unnecessary object. Therefore, the abnormal event check device 10 notifies at least the user terminal 300 of a fact that “something is left in the passenger room”. Accordingly, the user who left behind the user's object can turn back to get the user's object, which improves convenience. The user who abandoned the unnecessary object is urged to retrieve the unnecessary object to clean up the passenger room. As a result, it is suppressed that a next user boards the autonomous driving vehicle 100 in which the object left behind or the unnecessary object still remains.

As another example, in the case where the abnormal event is the “dirt occurrence”, it is preferable to make the autonomous driving vehicle 100 once return to a maintenance center for cleaning. Therefore, the abnormal event check device 10 notifies at least the management center 200 of the dirt occurrence. For example, the abnormal event check device 10 notifies the management server 210 of the dirt occurrence. The management server 210 instructs the autonomous driving vehicle 100 to return to the maintenance center. Alternatively, the management server 210 notifies an operator of the dirt occurrence through the operator terminal 220. The operator operates the operator terminal 220 to instruct the autonomous driving vehicle 100 to return to the maintenance center. As a result, it is suppressed that a next user boards the dirty autonomous driving vehicle 100.

As still another example, in the case where the abnormal event is the “part loss” or the “part damage”, it is preferable to make the autonomous driving vehicle 100 once return to a maintenance center for repair. Therefore, the abnormal event check device 10 notifies at least the management center 200 of the part loss or the part damage. As in the above-described case, the management center 200 (the management server 210 or the operator) instructs the autonomous driving vehicle 100 to return to the maintenance center. As a result, it is suppressed that a next user boards the autonomous driving vehicle 100 in which the part is lost or damaged. It is also possible to report the case to a public agency such as police in order to chase a criminal who caused the damage or loss. For example, the operator reports the case to a public agency such as police. Furthermore, the operator may retrieve an indoor image showing the criminal from the autonomous driving vehicle 100 and provide the indoor image to the public agency.

According to the present embodiment, as described above, the abnormal event check device 10 checks whether or not the abnormal event exists in the passenger room of the autonomous driving vehicle 100 after the user gets off. When the abnormal event exists, the abnormal event check device 10 notifies the user terminal 300 or the management center 200. Due to the notification, it is expected that the abnormal event is removed from the autonomous driving vehicle 100. As a result, it is suppressed that a next user boards the autonomous driving vehicle 100 in which the abnormal event still remains. This contributes to increase in confidence in the driverless transportation service. Moreover, deterioration of usefulness of the driverless transportation service is prevented.

### 3. Configuration Example of Autonomous Driving Vehicle

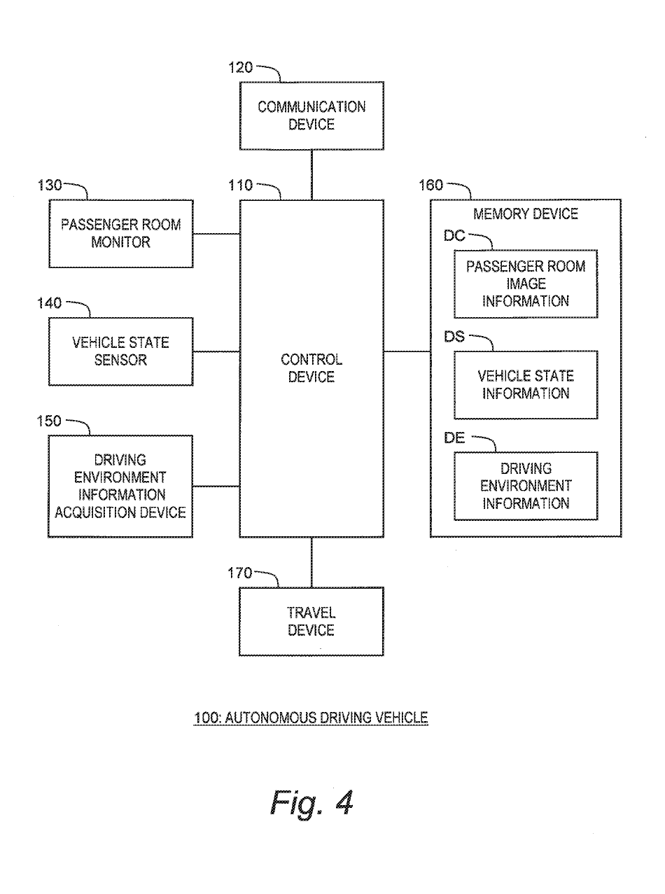

FIG. 4 is a block diagram showing a configuration example of the autonomous driving vehicle 100 according to the present embodiment. The autonomous driving vehicle 100 is provided with a control device 110, a communication device 120, a passenger room monitor 130, a vehicle state sensor 140, a driving environment information acquisition device 150, a memory device 160, and a travel device 170.

The control device 110 controls the autonomous driving of the autonomous driving vehicle 100. Typically, the control device 110 is a microcomputer including a processor and a memory. The autonomous driving control by the control device 110 is achieved by the processor executing a control program stored in the memory.

The communication device 120 communicates with the outside of the autonomous driving vehicle 100. More specifically, the communication device 120 communicates with the management server 210 and the user terminal 300 through the communication network. The control device 110 can communicate information with the management server 210 and the user terminal 300 through the communication device 120.

The passenger room monitor 130 includes an indoor camera that images the passenger room of the autonomous driving vehicle 100. The control device 110 can acquire an image and a video of the passenger room by using the passenger room monitor 130. For example, after the user gets off the autonomous driving vehicle 100, the control device 110 uses the passenger room monitor 130 to acquire the comparison-target image CMP. The image and the video of the passenger room acquired through the passenger room monitor 130 are hereinafter referred to as “passenger room image information DC”.

The vehicle state sensor 140 detects a variety of states of the autonomous driving vehicle 100. For example, the vehicle state sensor 140 includes a vehicle speed sensor that detects a speed of the autonomous driving vehicle 100 (i.e. a vehicle speed). The vehicle state sensor 140 may further include a door open/close sensor that detects opening/closing of a door of the autonomous driving vehicle 100. The vehicle state sensor 140 may further include a weight sensor that detects a vehicle weight. Based on the detection result by the vehicle state sensor 140, the control device 110 acquires vehicle state information DS indicating the state of the autonomous driving vehicle 100.

The driving environment information acquisition device 150 acquires driving environment information DE necessary for the autonomous driving control. The driving environment information DE includes position information, map information, surrounding situation information, and so forth. For example, the position information is acquired by a GPS (Global Positioning System) receiver. The map information is acquired from a map database. The surrounding situation information is information indicating a situation around the autonomous driving vehicle 100 and can be acquired by an external sensor. The external sensor is exemplified by a stereo camera, a LIDAR (Laser Imaging Detection and Ranging), and a radar. The surrounding situation information particularly includes target information regarding a target around the autonomous driving vehicle 100. The surrounding target is exemplified by a surrounding vehicle, a pedestrian, a roadside structure, a white line, and so forth.

The passenger room image information DC, the vehicle state information DS, and the driving environment information DE described above are stored in the memory device 160. The memory device 160 may be provided separately from the memory of the control device 110, or may be the same as the memory of the control device 110. The control device 110 reads necessary information from the memory device 160 as appropriate.

The travel device 170 includes a steering device, a driving device, and a braking device. The steering device turns wheels. The driving device is a power source that generates a driving force. The driving device is exemplified by an engine and an electric motor. The braking device generates a braking force. The control device 110 controls the travel device 170 to control travel (steering, acceleration, and deceleration) of the autonomous driving vehicle 100. For example, the control device 110 creates a travel plan based on the driving environment information DE, and makes the autonomous driving vehicle 100 travel in accordance with the travel plan.

Hereinafter, various examples of the abnormal event check processing by the use of the autonomous driving vehicle 100 will be described.

### 4. Various Examples of Abnormal Event Check Processing

### 4-1. First Example

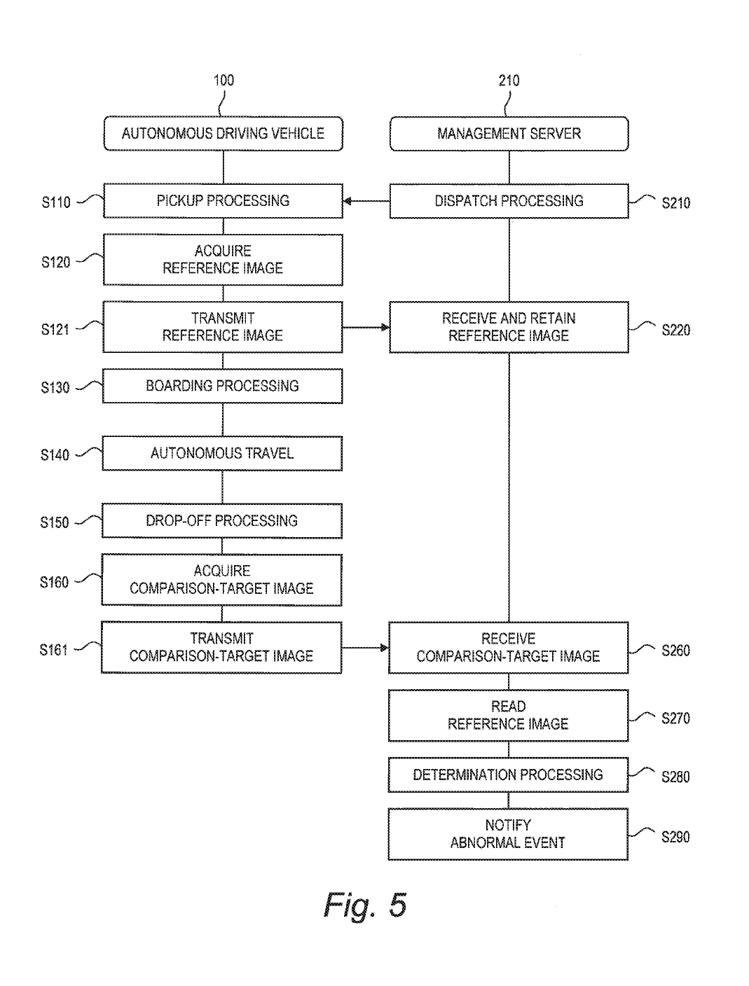

FIG. 5 is a flow chart showing a first example of the abnormal event check processing. In the first example, the abnormal event check device 10 is the management server 210.

The management server 210 performs dispatch processing in response to a dispatch request from the user (Step S210). More specifically, the management server 210 selects an autonomous driving vehicle 100 that provides the service for the user, and transmits information of the dispatch request to the selected autonomous driving vehicle 100.

The control device 110 of the autonomous driving vehicle 100 receiving the information of the dispatch request performs pickup processing (Step S110). More specifically, the control device 110 creates a travel plan for heading to the pickup location and makes the autonomous driving vehicle 100 travel in accordance with the travel plan. Then, the control device 110 makes the autonomous driving vehicle 100 stop at the pickup location. Stopping of the autonomous driving vehicle 100 at the pickup location can be recognized from the driving environment information DE (specifically, the position information and the map information) and the vehicle state information DS (specifically, the vehicle speed information).

A period from when the autonomous driving vehicle 100 receives the information of the dispatch request to when the user boards the autonomous driving vehicle 100 is hereinafter referred to as a “pickup period”. In the pickup period, the control device 110 uses the passenger room monitor 130 to acquire the reference image REF (Step S120). For example, the control device 110 acquires the reference image REF at the timing when the autonomous driving vehicle 100 stops at the pickup location. As another example, the control device 110 acquires the reference image REF at a timing when receiving an unlock request from the user.

After that, the control device 110 uses the communication device 120 to transmit the reference image REF to the management server 210 (Step S121). The management server 210 receives the reference image REF transmitted from the autonomous driving vehicle 100 and retains (holds) the received reference image REF in a memory device (Step S220). It should be noted that this Step S220 corresponds to Step S10 (i.e. the reference acquisition processing) shown in FIG. 3.

After the autonomous driving vehicle 100 stops at the pickup location, the control device 110 performs boarding processing (Step S130). For example, the control device 110 unlocks a door of the autonomous driving vehicle 100 in response to the unlock request from the user. The user takes a ride in the autonomous driving vehicle 100 and performs a predetermined authentication operation. The control device 110 performs authentication of the user. When the authentication of the user is completed, the control device 110 locks the door.

After that, the autonomous driving vehicle 100 autonomously travels toward the destination (Step S140). More specifically, the control device 110 creates a travel plan for heading to the destination and makes the autonomous driving vehicle 100 travel in accordance with the travel plan. Then, the control device 110 makes the autonomous driving vehicle 100 stop at the destination. Stopping of the autonomous driving vehicle 100 at the destination can be recognized from the driving environment information DE (specifically, the position information and the map information) and the vehicle state information DS (specifically, the vehicle speed information).

When the autonomous driving vehicle 100 arrives at the destination and stops, the control device 110 performs drop-off processing (Step S150). For example, the control device 110 performs charge processing. Then, the control device 110 unlocks the door and the user gets off the autonomous driving vehicle 100.

In the drop-off processing, the control device 110 further detects that the user gets off the autonomous driving vehicle 100. For example, when the door opens after the autonomous driving vehicle 100 stops and then closes again, it is considered that the user got off. Alternatively, when the vehicle weight decreases after the autonomous driving vehicle 100 stops, it is considered that the user got off. Therefore, the control device 110 can detect the getting-off of the user based on the vehicle state information DS (specifically, the vehicle speed information, the door open/close information, the vehicle weight information). Alternatively, the control device 110 may detect the getting-off of the user based on the passenger room image information DC acquired by the passenger room monitor 130.

After the user gets off the autonomous driving vehicle 100, the control device 110 uses the passenger room monitor 130 to acquire the comparison-target image CMP (Step S160). For example, the control device 110 acquires the comparison-target image CMP at a timing when the door of the autonomous driving vehicle 100 is closed. As another example, the control device 110 acquires the comparison-target image CMP after the elapse of a certain period of time after the getting-off of the user is detected.

After that, the control device 110 uses the communication device 120 to transmit the comparison-target image CMP to the management server 210 (Step S161). The management server 210 receives the comparison-target image CMP transmitted from the autonomous driving vehicle 100 (Step S260). It should be noted that this Step S260 corresponds to Step S20 (i.e. the comparison-target acquisition processing) shown in FIG. 3.

The management server 210 reads the reference image REF retained in the above-described Step S220 from the memory device (Step S270). This Step S270 also corresponds to Step S10 (i.e. the reference acquisition processing) shown in FIG. 3.

The management server 210 compares the comparison-target image CMP with the reference image REF to determine whether or not the abnormal event exists (Step S280). More specifically, the management server 210 determines whether or not there is a difference (change) between the comparison-target image CMP and the reference image REF. If there is the difference, the management server 210 analyzes a feature and a pattern of the difference portion to determine to which type (object addition, dirt occurrence, part loss, or part damage) of abnormal event the difference corresponds. It should be noted that this Step S280 corresponds to Step S30 (i.e. the determination processing) shown in FIG. 3.

When determining that the abnormal event exists, the management server 210 notifies the user terminal 300 or the operator of existence of the abnormal event (Step S290). It should be noted that this Step S290 corresponds to Step S40 (i.e. the abnormal event notification processing) shown in FIG. 3.

The control device 110 may acquire a video of the passenger room during a user ride period (i.e. a period from boarding to getting-off) by the use of the passenger room monitor 130. In this case, the control device 110 transmits the passenger room image information DC including the acquired video to the management server 210. For example, the acquired video is additionally used in the determination processing in Step S280. In this case, it is possible to identify an occurrence timing and cause of the abnormal event. It is also possible to analyze the acquired video for identifying the user who stole or damaged the part.

### 4-2. Second Example

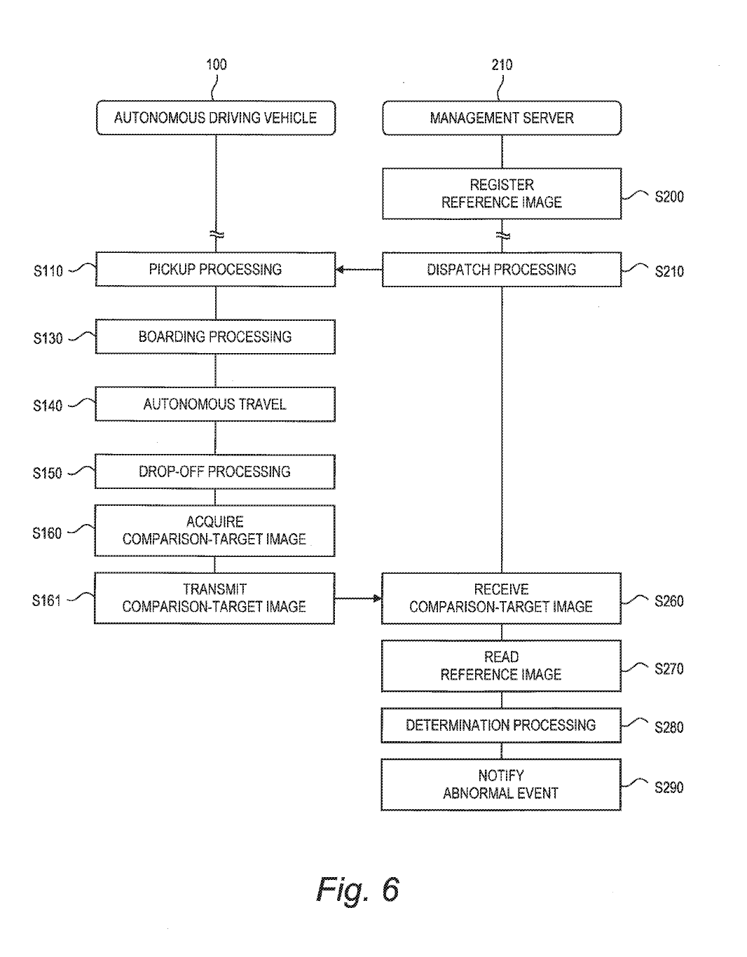

FIG. 6 is a flow chart showing a second example of the abnormal event check processing. Also in the second example, the abnormal event check device 10 is the management server 210. However, the method of acquiring the reference image REF is different from that in the above-described first example. An overlapping description with the first example will be omitted as appropriate.

As described above, the reference image REF is used as the reference for detecting the abnormal event. A period for acquiring the reference image REF is not limited to the pickup period immediately before the user boards the autonomous driving vehicle 100, as long as it can be used as the reference. For example, the reference image REF may be acquired when the autonomous driving vehicle 100 is in a standby state. Alternatively, the reference image REF may be acquired immediately after the autonomous driving vehicle 100 is manufactured. The reference image REF may be imaged by the passenger room monitor 130 or imaged by another means. The reference image REF thus acquired is beforehand registered in the memory device of the management server 210 (Step S200). It should be noted that this Step S200 corresponds to Step S10 (i.e. the reference acquisition processing) shown in FIG. 3.

In the second example, the control device 110 of the autonomous driving vehicle 100 need not acquire the reference image REF in the pickup period. That is, Steps S120 and S121 shown in FIG. 5 are omitted. In Step S270, the management server 210 reads the reference image REF registered in the above-described Step S200 from the memory device. The other processing is the same as in the case of the first example.

### 4-3. Third Example

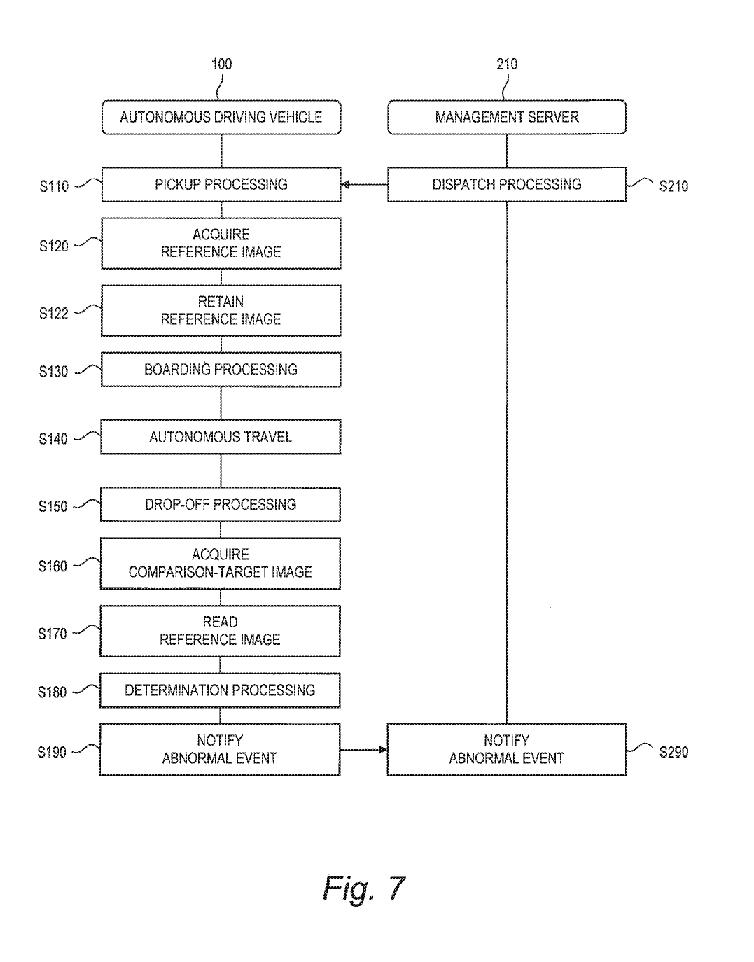

FIG. 7 is a flow chart showing a third example of the abnormal event check processing. In the third example, the abnormal event check device 10 is the control device 110 of the autonomous driving vehicle 100. An overlapping description with the first example will be omitted as appropriate.

As in the case of the first example, the control device 110 uses the passenger room monitor 130 to acquire the reference image REF in the pickup period (Step S120). Then, the control device 110 retains (holds) the acquired reference image REF in the memory device 160 (Step S122). It should be noted that these Steps S120 and S122 correspond to Step S10 (i.e. the reference acquisition processing) shown in FIG. 3.

After the user gets off the autonomous driving vehicle 100, the control device 110 uses the passenger room monitor 130 to acquire the comparison-target image CMP (Step S160). This Step S160 corresponds to Step S20 (i.e. the comparison-target acquisition processing) shown in FIG. 3.

The control device 110 reads the reference image REF retained in the above-described Step S122 from the memory device 160 (Step S170). This Step S170 also corresponds to Step S10 (i.e. the reference acquisition processing) shown in FIG. 3.

The control device 110 compares the comparison-target image CMP with the reference image REF to determine whether or not the abnormal event exists (Step S180). The determination method is similar to that in Step S280 described in the first example. It should be noted that this Step S180 corresponds to Step S30 (i.e. the determination processing) shown in FIG. 3.

When determining that the abnormal event exists, the control device 110 uses the communication device 120 to notify the user terminal 300 or the management server 210 of existence of the abnormal event (Step S190). It should be noted that this Step S190 corresponds to Step S40 (i.e. the abnormal event notification processing) shown in FIG. 3.

### 4-4. Fourth Example

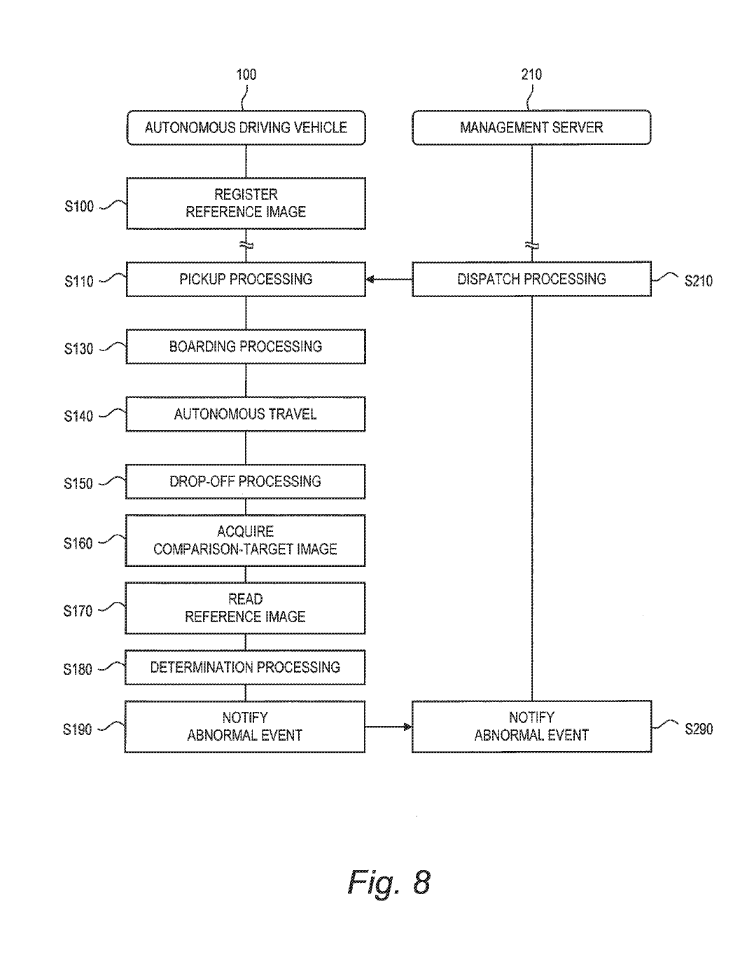

FIG. 8 is a flow chart showing a fourth example of the abnormal event check processing. Also in the fourth example, the abnormal event check device 10 is the control device 110 of the autonomous driving vehicle 100. However, the method of acquiring the reference image REF is different from that in the above-described third example. An overlapping description with the foregoing examples will be omitted as appropriate.

As in the case of the above-described second example, the reference image REF is beforehand acquired and registered in the memory device 160 of the autonomous driving vehicle 100 (Step S100). It should be noted that this Step S100 corresponds to Step S10 (i.e. the reference acquisition processing) shown in FIG. 3.

In the fourth example, the control device 110 of the autonomous driving vehicle 100 need not acquire the reference image REF in the pickup period. That is, Steps S120 and S122 shown in FIG. 7 are omitted. In Step S170, the control device 110 reads the reference image REF registered in the above-described Step S100 from the memory device 160. The other processing is the same as in the case of the third example.

What is claimed is:

1. A driverless transportation system that provides a driverless transportation service for a user, comprising:
an autonomous driving vehicle that the user boards; and
an abnormal event check device that checks whether or not an abnormal event exists in a passenger room of the autonomous driving vehicle after the user gets off,
the abnormal event being a change within the passenger room between before the user boards the autonomous driving vehicle and after the user gets off the autonomous driving vehicle,
wherein the autonomous driving vehicle comprises:
a passenger room monitor that images the passenger room; and
a control device that uses the passenger room monitor to acquire, as a comparison-target image, an image of the passenger room after the user gets off the autonomous driving vehicle, and
wherein the abnormal event check device performs:
reference acquisition processing that acquires a reference image being an image of the passenger room before the user boards the autonomous driving vehicle;
comparison-target acquisition processing that acquires the comparison-target image;
determination processing that compares the comparison-target image with the reference image to determine whether or not the abnormal event exists; and
abnormal event notification processing that notifies a terminal of the user or a management center managing the driverless transportation service, when it is determined that the abnormal event exists.

2. The driverless transportation system according to claim 1, wherein
the abnormal event includes at least one of object addition, dirt occurrence, part loss, and part damage within the passenger room as compared to before the user boards the autonomous driving vehicle.

3. The driverless transportation system according to claim 2, wherein
when the abnormal event is the object addition, the abnormal event notification processing includes notifying at least the terminal of the user.

4. The driverless transportation system according to claim 2, wherein
when the abnormal event is the dirt occurrence, the part loss, or the part damage, the abnormal event notification processing includes notifying at least the management center.

5. The driverless transportation system according to claim 1, wherein
the abnormal event check device is a management server placed in the management center,
the control device transmits the comparison-target image to the management server, and
the comparison-target acquisition processing includes receiving the comparison-target image transmitted from the autonomous driving vehicle.

6. The driverless transportation system according to claim 5, wherein
a pickup period is a period from when the autonomous driving vehicle receives information of a dispatch request made by the user to when the user boards the autonomous driving vehicle,
the control device uses the passenger room monitor to acquire the reference image in the pickup period and transmits the reference image to the management server, and
the reference acquisition processing includes receiving the reference image transmitted from the autonomous driving vehicle.

7. The driverless transportation system according to claim 5, wherein
the reference image is beforehand registered in the management server, and
the reference acquisition processing includes reading the registered reference image.

8. The driverless transportation system according to claim 1, wherein
the abnormal event check device is the control device.

9. The driverless transportation system according to claim 8, wherein
a pickup period is a period from when the autonomous driving vehicle receives information of a dispatch request made by the user to when the user boards the autonomous driving vehicle, and
the reference acquisition processing includes using the passenger room monitor to acquire the reference image in the pickup period.

10. The driverless transportation system according to claim 8, wherein
the reference image is beforehand registered in a memory device of the autonomous driving vehicle, and
the reference acquisition processing includes reading the registered reference image from the memory device.
